(19) United States
(12) Patent Application Publication
(10) Pub. No.: US 2026/0175060 A1
(43) Pub. Date: Jun. 25, 2026

(54) DRY POWDER FIRE EXTINGUISHER WITH IMPROVED GAS GENERATOR

(71) Applicant: Spectronix Ltd., Sderot (IL)

(72) Inventors: Alon MAMAN, Ofakim (IL); Dimitriy GRIGOROVITCH, Be'er Sheva (IL); Tsviel BOUHBUT, Be’er Sheva (IL); Meir GABAY, Ofakim (IL)

(21) Appl. No.: 18/991,964

(22) Filed: Dec. 23, 2024

(51) Int. Cl. A62C 5/00; A62C 99/00

(52) U.S. Cl. CPC A62C 5/008; A62C 99/0045

(57) ABSTRACT

A dry powder fire suppression system includes a container and a fire suppression powder disposed within the container. A rupture disk assembly is coupled to the container and is configured to allow powder to flow therethrough when at a specified pressure. A gas generator is coupled to the container and is configured to generate gas when triggered, the gas generator having a plurality of gas expulsion apertures, each gas expulsion aperture being configured to allow gas generated by the gas generator to flow into the container to pressurize the container and activate the rupture disk to allow the fire suppression powder to discharge from the container. A gas generation system for a dry powder fire suppression system is also provided.

### BACKGROUND

There are a wide variety of fire extinguishers and suppression systems in use today. Some systems are triggered automatically when a fire is detected while others are triggered by a user when actuated. Additionally, the flame retardant or extinguishing material varies based significantly including water, chemicals, foam, and powder with each type being more effective for a particular type of fire.

Dry powder type fire extinguishers employ a fire suppression powder, such as potassium bicarbonate, sodium bicarbonate or others. The dry powder type fire extinguisher is typically used for fighting burning solids, liquids and gases (Class A, B and C fires). A dry powder fire extinguisher can be used in a large variety of situations, these are as follows: Class A fires; fires that involve flammable solids like textiles, paper, and wood; Class B fires; fires that involve flammable liquids, for example, paint, diesel, and petrol; Class C fires; fires that involve flammable gases, for instance, butane or methane; and electrical fires where the electrical equipment is up to a maximum of 1000v. Specialist powder extinguishers are designed to tackle type D fires involving combustible metals such as lithium, magnesium, or aluminum.

Dry powder fire extinguishers, whether manual or automatic, typically rely on a propellant to force the powder out of a tank or container into the fire. In some cases, the propellant is maintained in a pressurized state within the container. An example manually actuated compressed gas fire extinguisher is the typical red tank consumer fire extinguisher available at local hardware stores.

Pressurized dispensers in fire suppression systems face significant challenges due to temperature fluctuations, which can cause pressure variations and compromise system effectiveness. Extreme temperatures make maintaining consistent pressure difficult, affecting the system's responsiveness during fires. Additionally, these systems require regular maintenance, including inspections and refilling, which incurs costs and demands time and resources. Over time, the risk of leaks increases as the structural integrity of the dispensers and their components may degrade. Addressing these leaks promptly is critical to ensure the system's reliability and safety.

Another type of dry powder fire suppression system employs a gas generator that, when triggered, quickly generates a significant amount of gas to virtually instantaneously pressurize the tank or container of the dry powder. This gas reaction is similar to, or in some cases the same as, the gas reaction used to inflate automotive airbags in a collision. Dry powder fire suppression systems that employ gas generators do not require as much maintenance and inspection as compressed gas type systems. Additionally, the systems can be made smaller than compressed gas system since a robust pressure tank (capable of maintaining the propellant gas at high pressures for extended periods of time) is not required. However, a limitation of some dry-powder gas generation fire suppression systems is that there is sometimes some dry powder left within the tank or container. Thus, providing a dry powder gas generated fire suppression system that more fully or completely discharges the dry powder from the tank or container would represent an improvement in the art.

### SUMMARY

A dry powder fire suppression system includes a container and a fire suppression powder disposed within the container. A rupture disk assembly is coupled to the container and is configured to allow powder to flow therethrough when at a specified pressure. A gas generator is coupled to the container and is configured to generate gas when triggered, the gas generator having a plurality of gas expulsion apertures, each gas expulsion aperture being configured to allow gas generated by the gas generator to flow into the container to pressurize the container and activate the rupture disk to allow the fire suppression powder to discharge from the container. A gas generation system for a dry powder fire suppression system is also provided.

### BRIEF DESCRIPTION OF THE DRAWINGS

FIG. 1 is a diagrammatic view of a gas-generating dry powder fire suppression device with which embodiments described herein are particularly applicable.

FIG. 2 is a block diagram of a method of operating a gas-generating dry powder fire suppression system.

FIG. 3 is a diagrammatic view of a portion of a gas-generating dry powder fire suppression system in accordance with the prior art.

FIG. 4 is a diagrammatic view of a portion of a gas-generating dry powder fire suppression system in accordance with an embodiment of the present invention.

FIG. 5 is a diagrammatic perspective view of a gas-generating dry powder fire suppression system in accordance with another embodiment of the present invention.

FIG. 6 is a diagrammatic cross-sectional view of the gas-generating dry powder fire suppression system shown in FIG. 5.

### DETAILED DESCRIPTION OF ILLUSTRATIVE EMBODIMENTS

Prior to describing various embodiments of the present invention, it is useful to first describe the operation of a gas-generating dry powder fire suppression device.

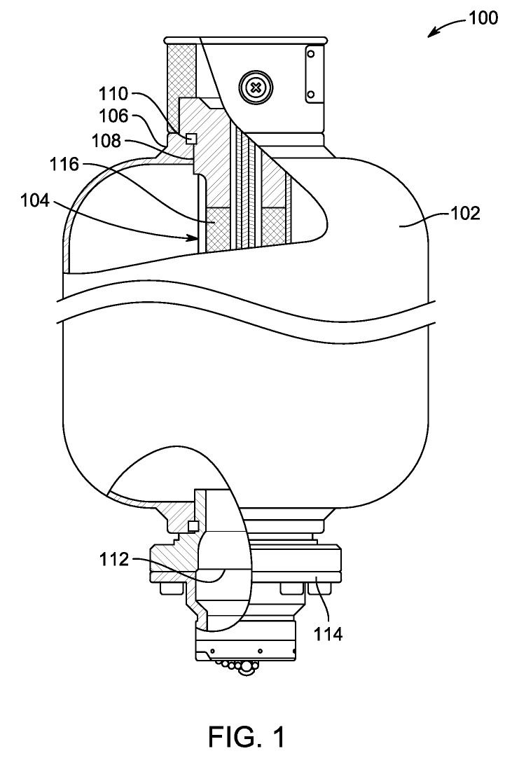

FIG. 1 is a diagrammatic view of a gas-generating dry powder fire suppression device with which embodiments described herein are particularly applicable. Fire suppression system 100 includes tank 102 having a gas generator module 104 centrally mounted to top portion 106 of tank 102 at interface 108, which is generally a threaded interface. A sealing element, such as o-ring 110 is disposed proximate interface 108 and helps seal gas generation module 104 to tank 102. A rupture disc 112 is disposed near a bottom portion of tank 102 and is configured to withstand pressurization up to a selected pressure at which, rupture disc 112 ruptures and allows pressurized dry powder to be expelled. Rupture disc 112 is generally housed within cover 114, which is attached to tank 102.

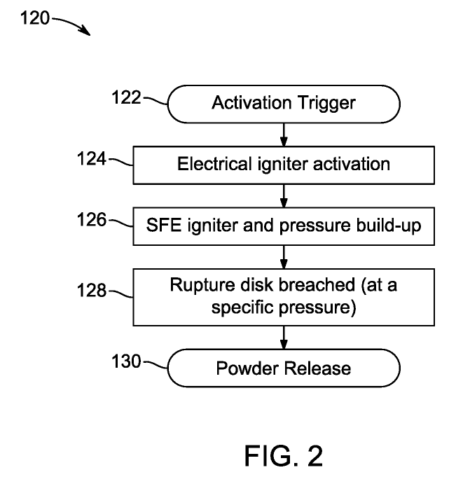

FIG. 2 is a block diagram of a method of operating a gas-generator based dry powder fire suppression system. Method 120 begins at block 122 by the actuation of an activation trigger mechanism such as a signal provided by a flame detection system or a user input. Subsequently, this triggers the activation of an electrical igniter within gas generation module 104, as indicated at block 124. Upon activation of the electrical igniter, a Spectronix Fire Extinguisher (SFE) propellant material 116 or any other type of propellant undergoes ignition, leading to a rapid build-up of internal pressure within the gas generation module 104 as indicated at block 126. The pressure is released into tank 102 through a single exit in the gas generation module 104 (shown in FIG. 1), creating pressure on the extinguishing agent disposed within tank 102. Once the internal pressure reaches a predetermined threshold, rupture disk 112, designed to fail at this specific pressure breaches, as indicated at block 128. This breach or rupture allows the powder to discharge into the environment as indicated at block 130. The breaching of rupture disk 112 facilitates the controlled release of the extinguishing powder into the protected environment.

A fire suppression system that employs an unpressurized tank or container and a gas generator ensures a consistent and controlled release of the powder without being affected by environments with temperature fluctuations or the form factor of the cylinder or tank 102. This technique also mitigates maintenance requirements. Unlike pressurized dispensers that demand frequent inspections and refilling, the gas generator-based dispenser minimizes maintenance needs. This reduction in maintenance efforts not only decreases operational costs but also enhances the overall efficiency of the fire suppression system.

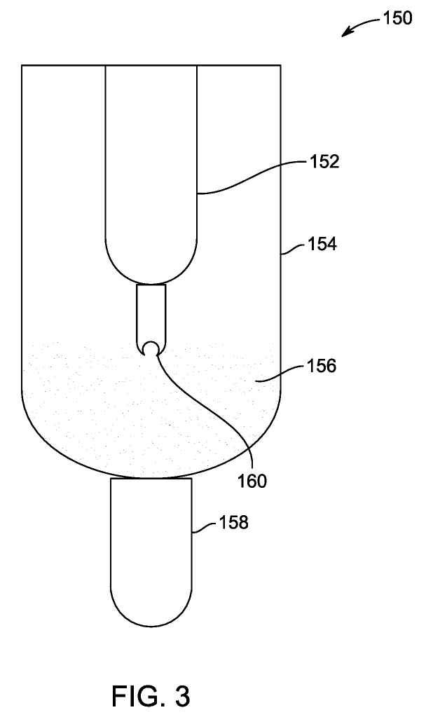

FIG. 3 is a diagrammatic view of a portion of a gas-generating dry powder fire suppression system. System 150 includes gas generation system 152 disposed within container or tank 154. Dry powder flame suppression material 156 is also disposed within tank 154 and a rupture disk 158 is mounted to or otherwise coupled to tank 154. When gas generation system 152 is triggered, gas generated within system 152 is expelled through single aperture 160 thereby pressurizing tank 154 until the rupture pressure of rupture disk 158 is reached at which time, the pressurized dry powder 156 is discharged. One limitation of the existing unpressurized cylinders is that the tank or cylinder 154 may not be fully emptied and a residue may be left in the tank due to pressurization from a single point 160 of the gas generation system. As a result, strict geometrical design constraints are generally imposed for the shape of a cylinder to reduce or minimize this undesirable effect.

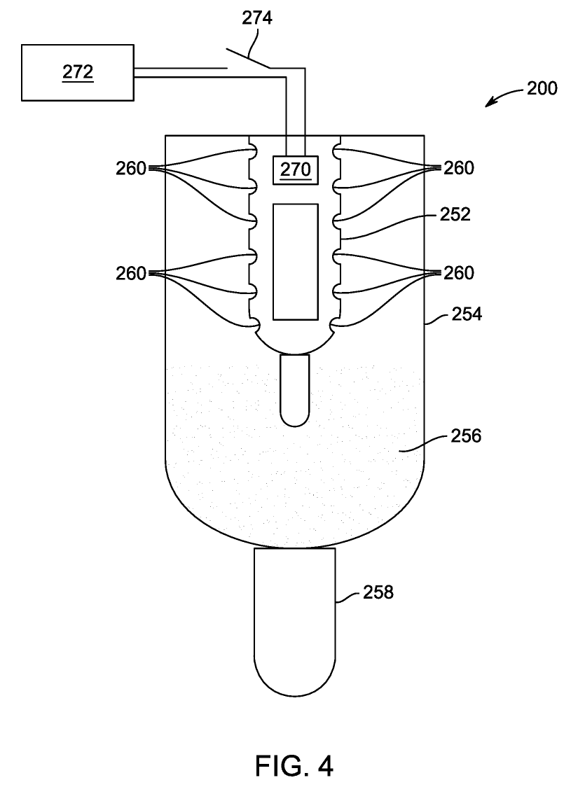

FIG. 4 is a diagrammatic view of a portion of a gas-generating dry powder fire suppression system in accordance with an embodiment of the present invention. System 200 bears some similarities to system 150 (shown in FIG. 3) and like components are numbered similarly. Gas generating dry powder fire suppression system 200 includes a gas generation module 252 disposed within tank or container 254. A dry powder fire suppression material 256 is also disposed within tank or container 254 and is generally in an unpressurized state until gas generation system 252 is triggered. System 200 also includes a rupture disk 258 mounted to or otherwise coupled to tank or container 254. An electrical igniter 270 is disposed within gas generation system 252 and is configured to ignite the gas generation propellant when energized by energization source 272 and trigger 274 (illustrated diagrammatically as a switch). Gas generation system 252 includes a plurality of gas expulsion apertures 260. Apertures 260 are configured to generate turbulent gas flow as the generated gas is expelled into tank or container 254. This turbulence helps ensure that powder 256 is completely discharged when rupture disk 258 ruptures at the pre-selected rupture pressure.

Embodiments described herein generally overcome limitations of existing technology by changing the geometry of the gas generator and/or gas generating propellant and its enclosure to create internal turbulence, causing internal pressure to build from more than one point and actually creating homogeneous pressure inside the cylinder. This helps ensure that the dry powder agent is discharged efficiently so that no residue is left in the cylinder. One particular advantage of embodiments described herein is the gas generator is highly effective for a variety of tank shapes and configurations. Thus, extinguishers can be manufactured having any suitable geometric shape and there will still be no residue left in the tank of the extinguisher.

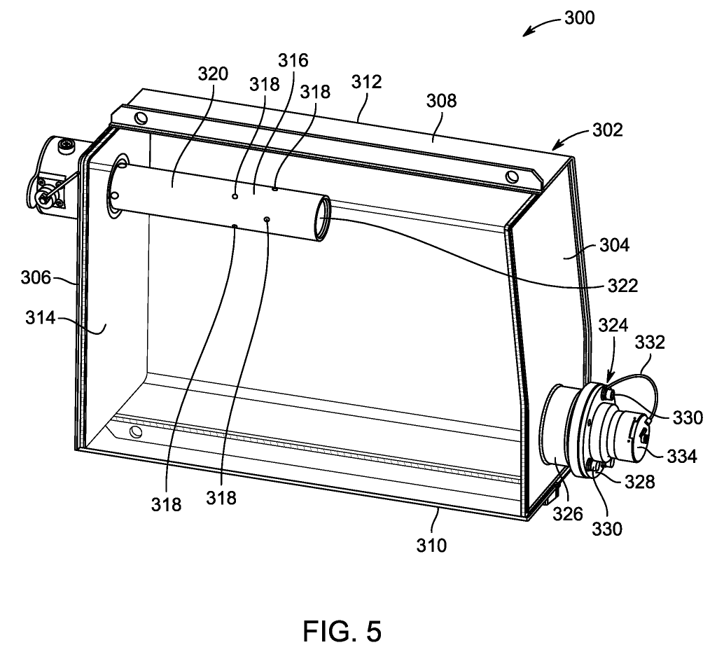

FIG. 5 is a diagrammatic perspective view of a gas-generating dry powder fire suppression system in accordance with another embodiment of the present invention. Gas-generating dry powder fire suppression system 300 includes a tank or container 302. In the illustrated embodiment, container 302 includes two relatively flat ends 304, 306 as well as top 308, bottom 310 and sidewalls 312 and 314. For the purpose of illustration, no fire suppression powder is shown and sidewall 314 is shown transparent to allow gas generation system 316 to be seen within container 302.

Gas generation system 316 is mounted to flat end 306 and extends into container 302. As can be seen, the location and orientation of gas generation system 316 relative to container 302 is not symmetric. Thus, gas generation system 316 may be coupled to any suitable container having any shape in any position and/or orientation. This provides significant configurability to allow embodiments disclosed herein to address a wide array of fire suppression applications and environments. As shown in FIG. 5, gas generation system 316 includes a plurality of gas expulsion apertures 318. In the illustrated embodiment, four gas expulsion apertures 318 are shown while another 4 are hidden from view. Apertures 318 may be axially spaced from one another, rotationally spaced from one another or both. Preferably, at least some apertures 318 are rotationally spaced from one another so that gas generation system 316 is effective in any mounting orientation within container 302. Gas generation system 316 generally includes a cylindrical sidewall 320 and a flat end 322. While gas expulsion apertures 318 are only shown in cylindrical sidewall 320 it is expressly contemplated that one or more gas expulsion apertures 318 may be provided on flat end 322.

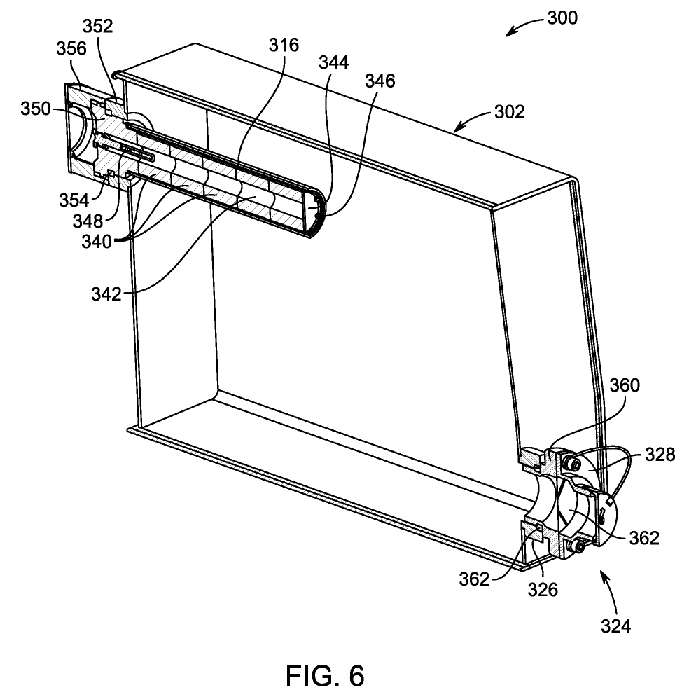

Rupture disk assembly 324 is shown mounted to flat end 304. In one example, rupture disk assembly threads into flange 326 on flat end 304. Rupture disk assembly includes a cover 328 that is mechanically attached to the assembly with a plurality of fasteners 330. Additionally, a cap 334 is removably attached to assembly 324 and tethered thereto with tether 332. When the rupture disk (shown in FIG. 6) ruptures, cap 334 simply pops off and allows the dry powder to discharge.

FIG. 6 is a diagrammatic cross-sectional view of the gas-generating dry powder fire suppression system shown in FIG. 5. FIG. 6 shows internal features of gas generation system 316 as well as rupture disk assembly 324.

Gas generation system 316 includes a number of cylindrical members 340 disposed adjacent to one another. Each cylindrical member 340 includes a central aperture such that when multiple cylindrical members are disposed adjacent to one another they define a central passageway 342. While cylindrical members 340 are shown, it is expressly contemplated that other geometrical shapes can be used as long as the member is robust enough to withstand the high pressure caused by the gas-generating propellant and effectively distribute the gas. The gas-generating propellant is placed within central passageway 342. An endcap 344 is then placed over the stack of cylindrical members 340 and held in place by a suitable fastener, such as snap ring 346. An ignitor 348 is disposed partially within body 350 and extends into central passageway 342 and thus is in contact with the gas-generating propellant. Body 350 is, in one embodiment, threaded into flange 352 of container 302 and includes an o-ring 354 to help seal body 350 to flange 352. Cap 356 is removably coupled to body 350 to allow interaction (replacement, maintenance, inspection) of ignitor 348. When the gas-generating propellant is ignited, the gas can pass through the interfaces between adjacent cylindrical members 340. Additionally, or alternatively, apertures can also be provided through the sidewalls of cylindrical members 340 to allow greater gas flow from central passageway 342 to the gas expelling apertures 318.

Internal features of rupture disk assembly 324 can be seen in FIG. 6. Rupture disk assembly 324 includes a body 360 that is removably mounted to flange 326. In the illustrated embodiment, body 360 is threaded into flange 326. However, embodiments can be practiced where flange 326 has external threads that engage internal threads of body 360. An o-ring or other suitable seal 362 is disposed between body 360 and flange 326 to help seal rupture disk assembly 324 to flange 326. Rupture disk 364 is mounted between body 360 and cover 320. Rupture disk 364 is configured, through material selection, thickness, and/or machining, to rupture or otherwise break at a selected pressure. Once rupture disk ruptures, it must be replaced. Thus, it is important for rupture disk assembly 324 to be serviceable.

Embodiments described above generally provide a new fast powder dispenser/extinguisher utilizing an advanced gas generator as a propelling mechanism. This new unpressurized dispenser is designed to release powdered substances rapidly. The gas generator serves as a reliable means of propulsion, ensuring fast and controlled dispensing of the powder. Additionally, fast powder dispenser based on an advanced gas generator described herein functions as an effective propelling mechanism for the release of powder, making it particularly suitable for applications where quick and consistent powder delivery is crucial, with limited space requiring un-symmetrical geometrical forms of tanks, cylinders, and/or containers.

Although the present invention has been described with reference to preferred embodiments, workers skilled in the art will recognize that changes may be made in form and detail without departing from the spirit and scope of the invention.

What is claimed is:

1. A dry powder fire suppression system comprising:
a container;
fire suppression powder disposed within the container;
a rupture disk assembly coupled to the container and configured to allow powder to flow therethrough when at a specified pressure; and
a gas generator coupled to the container, the gas generator being configured to generate gas when triggered, the gas generator having a plurality of gas expulsion apertures, each gas expulsion aperture being configured to allow gas generated by the gas generator to flow into the container to pressurize the container and activate the rupture disk to allow the fire suppression powder to discharge from the container.

2. The dry powder fire suppression system of claim 1, wherein the gas generator is mounted asymmetrically to the container.

3. The dry powder fire suppression system of claim 1, wherein the gas generator includes a cylindrical sidewall extending into the container.

4. The dry powder fire suppression system of claim 3, wherein the plurality of gas expulsion apertures includes at least some gas expulsion apertures that are axially spaced from one another on the sidewall.

5. The dry powder fire suppression system of claim 3, wherein the plurality of gas expulsion apertures includes at least some gas expulsion apertures that are rotationally spaced from one another on the sidewall.

6. The dry powder fire suppression system of claim 1, wherein the gas generator includes an ignitor coupled to gas-generating propellant.

7. The dry powder fire suppression system of claim 6, wherein the ignitor is an electrical ignitor.

8. The dry powder fire suppression system of claim 1, wherein the gas generator is removably mounted to the container.

9. The dry powder fire suppression system of claim 8, and further comprising a seal disposed between the gas generator and the container.

10. The dry powder fire suppression system of claim 1, wherein the rupture disk assembly is removably mounted to the container.

11. The dry powder fire suppression system of claim 10, and further comprising a seal disposed between the rupture disk assembly and the container.

12. A gas generation system for a dry powder fire suppression system, the gas generation system comprising:
a body mountable to a container of dry powder fire suppression material;
a sidewall extendable into the container, the sidewall having a plurality of gas expulsion apertures and being configured to contain gas generating propellant;
a gas generating propellant disposed within the sidewall and being configured to generate a gas when ignited; and
an ignitor disposed at least partially within the sidewall in contact with the gas generating propellant.

13. The gas generation system of claim 12, and further comprising a plurality of cylindrical members disposed adjacent to one another within the sidewall, each cylindrical member having a central aperture.

14. The gas generation system of claim 13, wherein the gas generating propellant is disposed within the central apertures of the cylindrical members.

15. The gas generation system of claim 12, wherein the ignitor is an electrical ignitor.

16. The gas generation system of claim 12, and further comprising an endcap removable coupled to a distal end of the sidewall.

17. The gas generation system of claim 16, wherein the endcap is a flat endcap.

18. The gas generation system of claim 12, wherein the plurality of gas expulsion apertures includes at least two gas expulsion apertures that are spaced apart axially on the sidewall.

19. The gas generation system of claim 12, wherein the plurality of gas expulsion apertures includes at least two gas expulsion apertures that are spaced apart rotationally on the sidewall.

20. The gas generation system of claim 12, wherein the plurality of gas expulsion apertures is configured to generate turbulent gas flow from the gas generation system.
